(19) United States
(12) Patent Application Publication
(10) Pub. No.: US 2010/0306643 A1
(43) Pub. Date: Dec. 2, 2010

(54) Methods and Systems for Processing Document Object Models (DOM) to Process Video Content

(75) Inventors: Timothy J. Chabot, Carol Stream, IL (US); Edwin D. Windes, Naperville, IL (US); Gregory J. Athas, Lisle, IL (US); Gang Li, Elk Grove Village, IL (US); Thomas Eric Hayosh, Lake Zurich, IL (US); Cesar Moreno, Forest Park, IL (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Nokia Corporation, Espoo (FI)

(21) Appl. No.: 12/750,544

(22) Filed: Mar. 30, 2010

Related U.S. Application Data
(60) Provisional application No. 61/164,625, filed on Mar. 30, 2009.

(51) Int. Cl. G06F 17/00

(52) U.S. Cl. 715/234

(57) ABSTRACT

Methods and systems for processing document object models (DOM) and to process video content are provided. Information content that is represented by a DOM and that includes a scripting language associated with the information content is received and original content of the DOM is preserved after execution of the scripting language. Further, video content is adapted for client devices. The scripting language associated with the information content can be sent to client device along with a modified DOM and processed video content. Pre-processing of the scripting language occurs to identify nodes related to video, and to maintain all other original nodes, for example.

### CROSS REFERENCE TO RELATED APPLICATION

The present patent application claims priority to U.S. Provisional Patent Application Ser. No. 61/164,625, filed on Mar. 30, 2009, the entire contents of which are incorporated herein by reference as if fully set forth in this description.

### FIELD

The present application relates generally to the field of web browsing and network communications. More specifically, the application relates to a system and method for adapting and presenting information from web pages for display on a client device.

### BACKGROUND

Today, many worldwide web pages (HyperText Markup Language (HTML) documents) are available that offer a variety of textual and non-textual content types. As known, a Web page is conventionally formatted via a standard page description language such as HTML, which typically contains text and can reference graphics, sound, animation, and video data. HTML provides for basic document formatting and allows a Web content provider to specify anchors or hypertext links to other Web servers and files. When a user selects a particular hypertext link, a Web browser reads and interprets an address, referred to as a Uniform Resource Locator (URL) associated with the link, connects with a Web server at that address, and initiates a hypertext transfer protocol (HTTP) request for the file identified in the link. The Web server then sends the requested file to a Web browser to interpret and display the file to the user.

On a traditional desktop or laptop personal computer with a large screen running a standard web browser, HTML content types are easily arranged and displayed for viewing. For example, web sites for searching realtor property listings often deliver a plurality of images and text for the viewer to quickly scan for a property of interest. When the user identifies a property of interest, the user can then read the details associated with the image of that specific property and select that image for further details about the property.

At the same time, the field of communications, and more specifically wireless telecommunications, is currently expanding. This technological expansion allows an electronic device, such as mobile personal digital assistant (PDA), cellular phone, pager, mobile computer, and other electronic devices to connect to the same information sources, such as a web server or database, as one could with the traditional personal computer (PC) and a PC-based browser. Several small device client browsers are available that deliver content from the web to the hand-held devices.

However, these small devices typically lack the screen space or navigation capabilities to display web content intended for display on a desktop or laptop computer. For example, hand-held devices may have displays that are small in size compared with desktop computer displays, and may have less processing power as compared with desktop computers. Thus, portions of Web content, such as images and text that are otherwise displayable on a desktop computer display may not be displayable on a hand-held computing device display unless some modifications are made to the images or text. In addition, handheld devices may not be able to display content that may require more processing, such as flash content and video, due to a lack of processing power.

### SUMMARY

In an example aspect, a method of providing information content for display is provided. The method comprises receiving information content that is represented by a document object model (DOM) and that includes a scripting language associated with the information content, and executing the scripting language on the DOM resulting in modifications being performed on the DOM. The method also includes inserting a switch node into the DOM at positions where the scripting language modified the DOM, where the switch node has a first branch that indicates original content of the DOM and a second branch that indicates modifications performed by the scripting language. The method further includes if the switch node has a branch that indicates a first data content, marking the switch node, processing the DOM by following branches of the switch nodes such that for marked switch nodes modified branches are traversed and for unmarked switch nodes original branches are traversed, and outputting a processed DOM.

In another example aspect, a computer readable medium is provided that has stored therein instructions executable by a computing device to cause the computing device to perform functions of receiving information content that is represented by a document object model (DOM) and that includes a scripting language associated with the information content, and executing the scripting language on the DOM resulting in modifications being performed on the DOM. The functions also include inserting a switch node into the DOM at positions where the scripting language modified the DOM, where the switch node has a first branch that indicates original content of the DOM and a second branch that indicates modifications performed by the scripting language. The functions also include if the switch node has a branch that indicates a first data content, marking the switch node, processing the DOM by following branches of the switch nodes such that for marked switch nodes modified branches are traversed and for unmarked switch nodes original branches are traversed, and outputting a processed DOM.

In still another example aspect, a server is provided that comprises a processor, and memory including machine language instructions executable by the processor to perform functions comprising receiving information content that is represented by a document object model (DOM) and that includes a scripting language associated with the information content, and executing the scripting language on the DOM resulting in modifications being performed on the DOM. The functions also comprise inserting a switch node into the DOM at positions where the scripting language modified the DOM, where the switch node has a first branch that indicates original content of the DOM and a second branch that indicates modifications performed by the scripting language, and if the switch node has a branch that indicates a first data content, marking the switch node. The server also includes a normalizer for processing the DOM by following branches of the switch nodes such that for marked switch nodes modified branches are traversed and for unmarked switch nodes original branches are traversed, and for outputting a processed DOM.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example system for accessing, adapting, and presenting information content to electronic devices.

FIG. 2 illustrates a block diagram of an example computing device.

FIG. 3 is an example conceptual document object model (DOM) represented as a tree-structure.

FIG. 4 is a flowchart that depicts example steps of a method for providing information content.

FIG. 5 is another example conceptual DOM represented as a tree structure.

FIG. 6 illustrates an example conceptual DOM represented as a tree structure, and an instance in which a scripting language modifies a script node.

FIG. 7 illustrates an example conceptual DOM represented as a tree structure, and an instance in which a scripting language modifies a general node.

FIG. 8 illustrates an example conceptual DOM represented as a tree structure, and an instance in which a scripting language modifies a general node by removing children.

FIG. 9 illustrates an example conceptual DOM represented as a tree structure, and an instance in which a scripting language modifies the DOM by inserting a new node before the node being modified.

FIG. 10 illustrates an example conceptual DOM represented as a tree structure, and an instance in which a scripting language modifies the DOM by inserting a new node after the node being modified.

FIG. 11 illustrates an example conceptual DOM represented as a tree structure, and an instance in which a scripting language modifies a node by altering an attribute value.

FIG. 12 illustrates an example conceptual DOM represented as a tree structure, and an instance in which a scripting language modifies replaces children of a given node with contents specified as an HTML string (e.g., performs Javascript function “setInnerHtml”).

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and are made part of this disclosure.

In example embodiments, information content is represented by a document object model (DOM) and includes a scripting language associated with the information content. Methods operate to execute the scripting language, to preserve original content of the DOM, and to adapt video content for client devices. In addition, the scripting language associated with the information content can still be sent to a client device and executed by the client device, rather than a server executing the scripting language and fully modifying the DOM, which would then be sent to the client device without the scripting language. By sending the scripting language to the client device, the client device may perform more functionality of the website. Furthermore, video content of the information content may be processed to present the client device with a preview image and a link, which a user of the client device may select to request the video for display. The server may receive the request, adapt the video for viewing on the client device, and send the adapted or transcoded video to the client device.

According to example embodiments, switch nodes can be added to the DOM during processing, and those related to video content can be marked. Once these nodes are added to the DOM and marked, a server (e.g., adaptive content accelerator (ACA)) can be operated to add a still image and a real time streaming protocol (RTSP) link to the main document DOM. Pre-processing of the scripting language occurs to identify nodes related to video, and to maintain all other original nodes, for example.

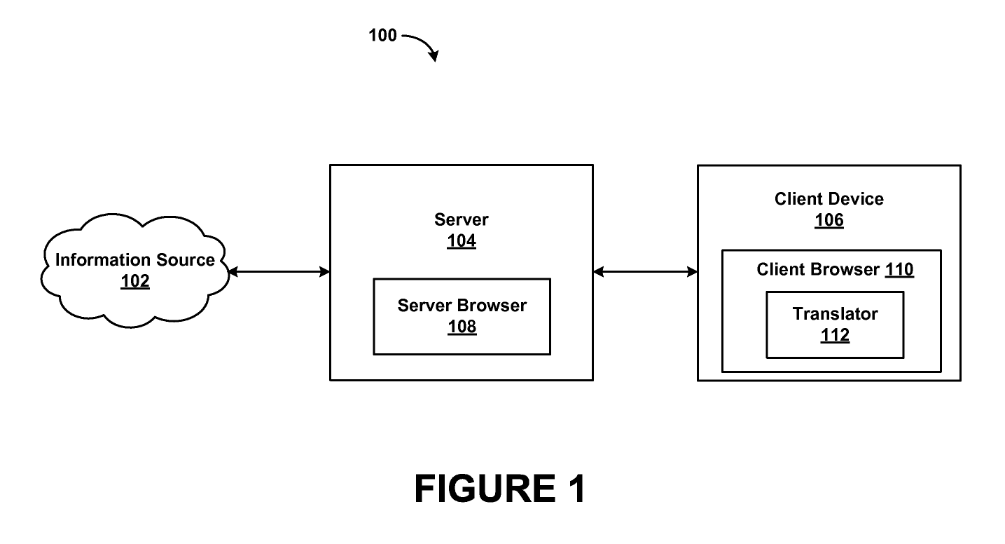

Referring now to FIG. 1, a high-level diagram is shown illustrating an exemplary system 100 for accessing, adapting, and presenting information content to electronic devices. The system 100 includes an information source 102, a server 104 and a client device 106.

The information source 102 includes any type of device such as a web server, application server, database or other backend system, or any interface to an information provider. The information source 102 may further comprise multiple devices or interfaces that enable connection to information content. The information source 102 provides information content expressed in a markup language, such as, for example, those markup languages known in the art including Hypertext Markup Language (HTML), Extensible Markup Language (XML) with or without Extensible Style Sheets (XSL), VoiceXML, Extensible Hypertext Markup Language (XHTML), Wireless Markup Language (WML), or other types of languages as can be processed by the client device 106. Furthermore, the information content can reference text, images, video, or audio information to be provided by the information source 102. The information content may be a website or web page, or multiple web pages, for example.

The information source 102 can be accessed through any type of network by the server 104 via a server browser 108. The server browser 108 may communicate with the client device 106 over any type of network through a client browser 110. The server browser 108 may perform as a proxy between the client browser 110 and the information source 102 for web page content for viewing. The server browser 108 may operate as a client of the information source 102 to retrieve the information content. For example, using a known suite of communications protocols such as Transmission Control Protocol/Internet Protocol (TCP/IP), the server browser 108 can issue a Hypertext Transfer Protocol (HTTP) request to the information source 102. By utilizing HTTP requests, the server browser 108 can access information content, including applications, static, and dynamic content at the information source 102.

The server browser 108 and the client browser 110 may reside on the same platform or may be separate from each other. For example, the server browser 108 might be hosted on a back-end server, and the client browser 110 might be hosted on a hand-held electronic device, as shown in FIG. 1. Alternatively, the client device 106 and the server 104 may co-exist on the same device, and thus, functionality of either can be substituted by each other. For example, the server browser 108 and client browser 110 can be hosted on the same platform such as on an electronic device, if the platform or electronic device has the appropriate hardware and network capabilities. Thus, within many embodiments herein, functionality may be described as being part of the client browser 110 or as being part of the server browser 108. The client browser 110 may perform functions explained as being performed by the server browser 108, and the server browser 108 may perform functions explained as being performed by the client browser 110. By utilizing the server and client browser, electronic devices with limited hardware capability can access feature rich information or data.

Generally, the server 104 and the client device 106 include a central processing unit, a memory (a primary and/or secondary memory unit), an input interface for receiving data, an input interface for receiving input signals from one or more input devices (for example, a keyboard, mouse, etc.), and an output interface for communications with an output device (for example, a monitor). In general, it should be understood that the server 104 and the client device 106 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data. It should also be noted that the server 104 and the client device 106 may generally execute application programs resident at the server 104 and the client device 106 under the control of an operating system. The application programs, such as the server browser 108 and the client browser 110, may be stored on memory within the server 104 and the client device 106 and may be provided using machine language instructions or software with object-oriented instructions, such as the Java programming language. However, other programming languages (such as the C++ programming language for instance) could be used as well.

As an example, the client browser 110 may reside on the client device 106, which may be an electronic device including any of a personal computer (PC), wireless telephone, personal digital assistant (PDA), hand-held computer, network appliance, and a wide variety of other types of electronic devices that might have navigational capability (e.g., keyboard, touch screen, mouse, etc.) and an optional display for viewing downloaded information content. Furthermore, the client device 106 can include any type of device that has the capability to utilize speech synthesis markups such as the World Wide Web Consortium (W3C) Voice Extensible Markup Language (VoiceXML). One skilled in the art of computer systems will understand that the example embodiments are not limited to any particular class or model of computer employed for the client device 106 and will be able to select an appropriate system.

Within the example, the client browser 110 resides on the client device 106, and also a PC hosts the server browser 108, and the client device 106 and PC are both connected to an Ethernet network. Then, the client browser 110 and the server browser 108 could perform information transactions over the Ethernet network. Such transactions would utilize Ethernet or similarly IEEE 802.3 protocols. Nevertheless, in this example, the client and server browsers communicate over a wired network. The communications might also include a wireless network such as a local area wireless network (LAWN), a wireless local area network (WLAN), or a cellular wireless network. Moreover, the communications might include wireless networks that utilize other known protocols and technologies such as Bluetooth, wireless application protocol (WAP), time division multiple access (TDMA), or code division multiple access (CDMA).

Referring again to FIG. 1, the client browser 110 can send a request for information to the server browser 108. The client browser 110 may include an event translator 112 to convert a request/response protocol, such as an HTTP request, from the client browser 110 (e.g., WML, XHTML, cHTML, etc.) to an event that the server browser 108 recognizes. The translation process could include event information, content information, and the context of the event such that transactions between the client browser 110 and the information source 102 (e.g. HTML form submission) are preserved.

Information content from the information source 102 is retrieved and can be tailored for use on the client browser 110 by the server browser 108. Alternatively, the server browser 108 may retrieve the information and send the information to the client browser 110, which itself tailors the information appropriately for viewing. Content transformations may be necessary since the requested content (e.g., a web page) could have been initially designed for viewing on a large screen of a PC, rather than on a limited screen size of a hand-held device. As a result, either the server browser 108 and/or the client browser 110 can perform information content rendering transformations or apply device specific style sheets to aid in presentation (e.g., display or voice) and navigation (e.g., keyboard, touch screen, or scrolling), and perform content grouping for electronic devices that accepts data in limited quantities.

To deliver these capabilities, the server browser 108 or client browser 110 may include modules (not shown) including a user agent, cookie handler, document object model (DOM), script executor, normalizer, and serializer, for example. Additional information pertaining to information content transformation or customization is included in U.S. Pat. No. 7,072,984, entitled “System and method for accessing customized information over the internet using a browser for a plurality of electronic devices,” U.S. Patent Application Publication No. 2004/0049737, entitled “System and Method for Displaying Information Content with Selective Horizontal Scrolling,” U.S. Pat. No. 7,500,188, entitled “System and Method for Adapting Information Content for an Electronic Device,” U.S. Patent Application Publication No. 2007/0073777, entitled “System and Method for Web Navigation Using Images,” and U.S. Patent Application Publication No. 2008/0195692, entitled “Method and System for Converting Interactive Animated Information Content for Display on Mobile Devices,” the contents of each of which are incorporated herein by reference as if fully set forth in this description.

The system 100 includes software (within the client device 106 or the server 104) for modifying web content into a format for display on the client device 106. As used herein, web content may refer to a web page received from information source 102, or a file downloaded from information source 102. Web content, as an example, may include blocks of text, pictures, audio, or video files. Modifying web content that has one characteristic to form web content that has a different characteristic is referred to as web content rendering, and more generally as rendering. Example characteristics of web content can include (but are not limited to) font metrics, image sizes, video bit rates, etc.

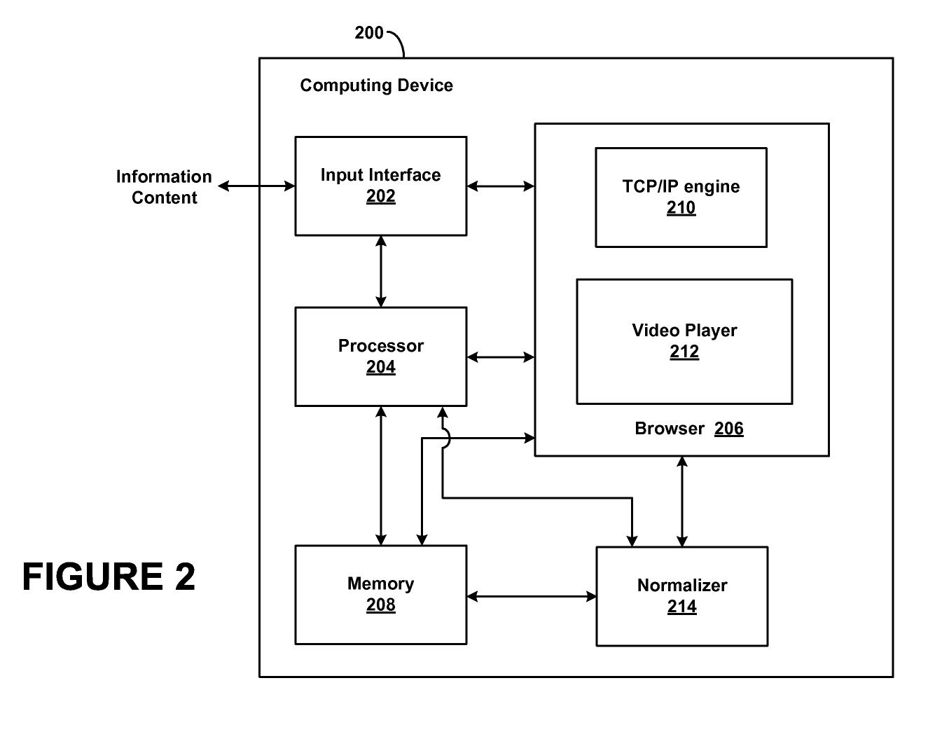

FIG. 2 illustrates a block diagram of an example computing device 200. In one example, the computing device 200 may operate as a client device, as shown in FIG. 1. In another example, the computing device 200 may operate as a server, as shown in FIG. 1. The computing device 200 receives information content at an input interface 202. The information content may be received from an information source, or from an intermediate proxy server, for example. The information content may be in the form of website data, and may be transcoded for viewing on a client device, or alternatively, may be received in a native form and can be transcoded (if needed) by the computing device 200.

The input interface 202 connects to a processor 204 and a browser 206. The processor 204 may process data and control functionality of components in the computing device 200. The processor 204 may be embodied as a processor that accesses memory 208 to execute software functions stored therein. One skilled in the art of computer systems design will understand that the example embodiments are not limited to any particular class or model of processor. The processor 204 may operate according to an operating system, which may be any suitable commercially available embedded or disk-based operating system, or any proprietary operating system. Further, the processor 204 may comprise one or more smaller central processing units, including, for example, a programmable digital signal processing engine or may also be implemented as a single application specific integrated circuit (ASIC) to improve speed and to economize space. In general, it should be understood that the processor 204 could include hardware objects developed using integrated circuit development technologies, or yet via some other methods, or the combination of hardware and software objects that could be ordered, parameterized, and connected in a software environment to implement different functions described herein. Also, the hardware objects could communicate using electrical signals, with states of the signals representing different data.

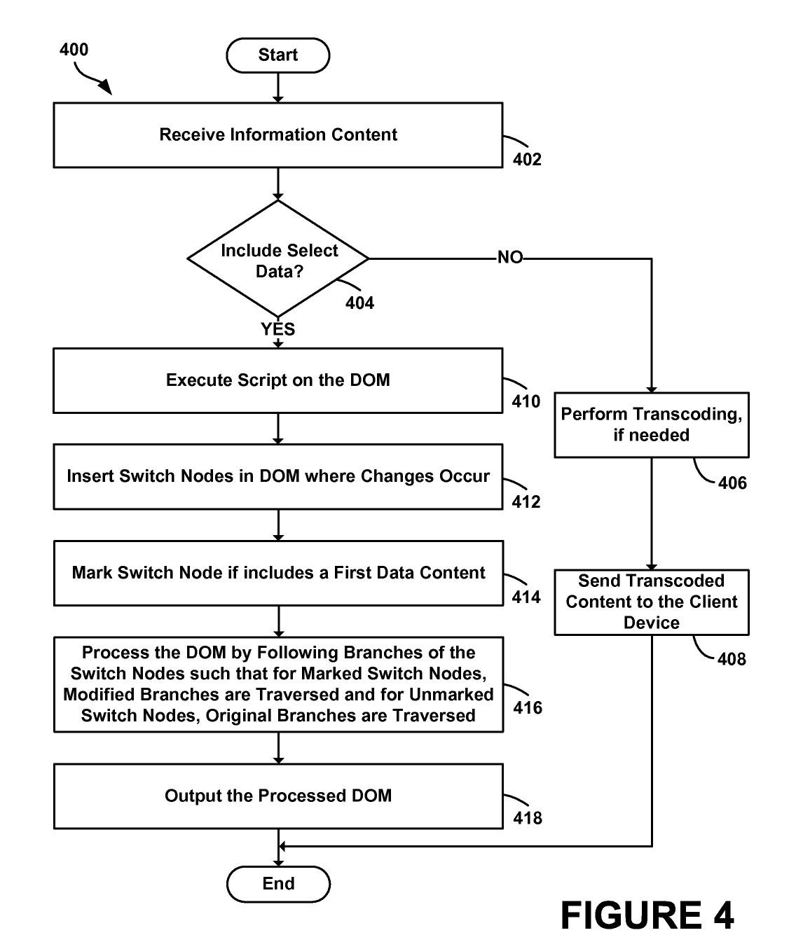

The memory 208 may store information such as previously transmitted or received signals, for example. The memory 208 may include random access memory (RAM), flash memory or long term storage, such as read only memory (ROM) or magnetic disks, for example. The memory 208 may store machine language instructions that are executable by the processor 204 to execute functions as described herein (e.g., such as the method shown in FIG. 4).

The browser 206 may include a TCP/IP engine 210 and a video player 212. The browser 206 may receive the information content and prepare the information content for display. To do so, the browser 206 may format the information content as needed, such as by transcoding the content for display on a handheld device. In this regard, the browser 206 may operate as a server browser to transcode the information content to be sent to a client device. Alternatively, the browser 206 may operate as a client browser with full functionality for transcoding the information content upon receipt of the content from a server, for example. Or, the browser 206 may have limited functionality as a client browser and may receive the information content and display the content in the form received, for example.

The TCP/IP engine 210 operates to receive and send requests for information content. The computing device 200 can be operated by the processor 204 to convert information content into a form accessible by a requesting client device. For example, a client device may request a typical web page, and thus the computing device 200 will access the Internet and retrieve the requested web page and then the browser 206 can convert the web page into a form accessible by the client device. In some instances, the web page will include video, movie, or flash player content, and thus the computing device 200 will retrieve and load the web page on the browser 206 using the video player 212. The browser 206 can then modify the web page or video content as needed, and send the modified content to a client device. Alternatively, the computing device may operate as a client device and may be operated to perform the modification and transcoding at the client device.

The computing device 200 may further include a normalizer as a separate element 214, or as a component of the processor 204 or browser 206. The normalizer 214 may be operated to transform or transcode information content into a format for display on a client device, for example.

A number of techniques are available for client or hand-held browsers to utilize to assist the user in navigating web pages. For example, client browsers may alter the layout of web content, change the positioning of images or a size of textual characters, or alter a web page to operate for display on the client device.

Web pages generally comprise a series of nested objects. The objects make up a Document Object Model (DOM) of the web page. The DOM is a platform neutral and language neutral interface that allows programs and scripts to dynamically access and update content, structure, and style of the object, for example. The DOM can be further processed and results of the processing can be incorporated back into the web page, for example. The DOM may be represented in a form of an HTML language and define a standard way for accessing and manipulating HTML documents. In one example, the DOM may be an HTML document and may be represented as a tree-structure.

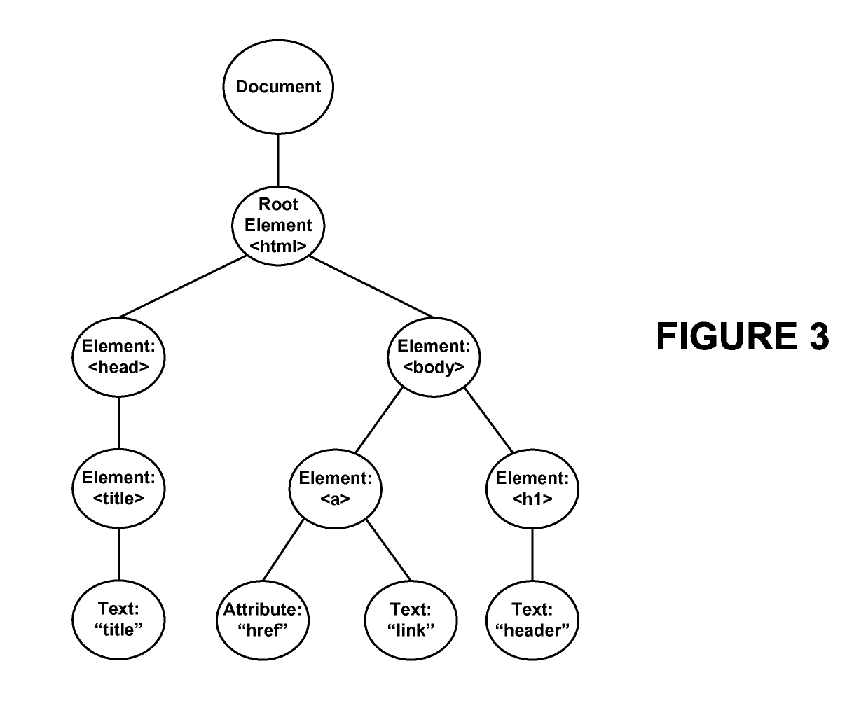

FIG. 3 is an example conceptual DOM represented as a tree-structure. The DOM includes an HTML document. The HTML document comprises HTML elements which, in a general form, have three components: a pair of element tags with a start tag and an end tag, element attributes given to the element within the tags, and textual and graphical information content that will be rendered on the display. The tags are surrounded by angle brackets within the web page content. The HTML document can also include or can load scripts in languages such as Javascript, which affect behavior of HTML processors such as web browsers, and Cascading Style Sheets (CSS) to define an appearance and layout of text and other material. In the example illustrated in FIG. 3, the HTML document may be in the form as shown in Table 1 below.

TABLE 1

<html>

<head>

<title>title</title>

</head>
<body>

<h1> header </h1>
<a href = hyperlink>link</a>

</body>

</html>

To represent the HTML document as a tree structure, a root element of “<html>” begins the tree, and offers branches to a next sub-level of elements, such as the head and body elements of the HTML document. The head branch includes the element title, and ends with the text of “title”. The body branch has two branches itself including an anchor element “<a>” and a header element “<h1>”. Each of these branches includes text, and the anchor element branch also includes an attribute of the hyperlink.

HTML documents or web pages may also include a scripting language or protocol associated with or included in the web page. One example of a scripting language is Javascript, which is an object-oriented scripting language used to enable programmatic access to objects within a client application and other applications. Javascript engines may be implemented as a component of a web browser, and when Javascript is encountered in a web page, the Javascript engine may execute the Javascript to provide enhanced user interfaces and dynamic websites, for example.

When a scripting language is executed, the scripting language may modify the DOM to provide more functionality to be displayed on the web page. For example, the scripting language may be executed, and when video content on the web page is encountered, the scripting language may indicate to load a video player to display the video content. Scripting language may indicate to load other applications, or to display items in a functional manner on the web page, for example.

The present application describes systems and methods for enabling video support on client devices. When a client device requests information content, such as a web page, a server may receive the request and retrieve the web page. The server may then execute any scripting language associated with the website and modify an original DOM of the website as indicated by the executed scripting language, or only modify the original DOM of the website with respect to aspects of the DOM relating to or including video content, for example. For instance, the server can execute scripting language and modify the DOM in order to process video content within the requested website, and send the modified DOM to the client device. The client device may then be able to display the processed video content.

Methods may be performed depending on a type and style of a client device. For example, on client devices (e.g., wireless telephones) classified with a certain browser capability, such as browser capability similar to a desktop computer (e.g., high-end phone (HEP) mode), video may be provided to the client device via the client browser in a streaming video process. The browser capability may vary per client device, and browser requirements may also vary depending on the type and amount of video to be delivered and displayed on the client device.

FIG. 4 is a flowchart that depicts example steps of a method 400 for providing information content. In one example, the method 400 may be performed by a server or proxy server, as shown in FIG. 1. In another example, the method 400 may be performed by a client device, as shown in FIG. 1.

The flowchart of FIG. 4 shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium, for example, such as a storage device including a disk or hard drive. In addition, each block may represent circuitry that is wired to perform the specific logical functions in the process. Alternative implementations are included within the scope of the example embodiments of the present application in which functions may be executed out of order from that shown or discussed, including substantially concurrent or in reverse order, depending on the functionality involved, as would be understood by those reasonably skilled in the art.

In the example in which the method 400 is performed by a server, the server may receive a request for information content from a client device, for example, and the server will receive the information content from an information source, as shown at block 402.

Following, the server may determine if the information content includes selected data (e.g., such as video data), as shown at block 404. For example, the server may reference a list that includes websites that have video data, and if the information content is on the list, the server may determine that the information content includes video data. An example list may include an operations, administration, maintenance, and provisioning (OAMP) list for high-end phone (HEP) video websites. Alternatively, the server may search the information content for HTML identifiers, such as an embed or object tag, that indicate the information content includes video data. Depending on the type of data being searched, the server may locate and identify whether the information content includes such data.

Still alternatively, block 404 may be removed, and the method 400 may be performed on all information content. However, performing block 404 may lesson processing of information content for instances in which the information content does not include video data. Furthermore, block 402 may be performed on information content if the information content at least potentially includes video data, for example.

Still alternatively, bock 404 may be removed, and the method 400 may be performed only for requesting devices that do not support video, for example.

Video data may include any type of data including animation such as Adobe Flash, Microsoft Silverlight, Sun JavaFX, W3C SVG, Windows media, RealMedia, Quicktime, MPEG, etc. Such data may be provided in data files that have a variety of forms, such as an (swf) file extension, an (fly) file extension, an (fla) file extension for source material, and MPEG file extensions, for example. Data may also be deemed to be video data depending on an identifier of the data within the information content. For example, if data is included or referenced by an HTML embed or object tag, the data may be considered to be a type of video data.

If the information content does not include video data, then the server may perform transcoding of the information content, if needed, as shown at block 406. Many different content transformations or transcoding can occur based on information present within a requested web page, for example. Interactive animated content information in particular calls for an appropriate transformation. Animation and special effects may be included within web page content using frame driven scalable vector graphics files, and such content will be transformed for viewing on the client device. For example, animations may be presented that include starting and ending frames and animation for the frames in between. An object's size, rotation, color, or other attributes may be varied between the starting and ending key frames to create the appearance of movement. Alternatively, animation may be presented by changing the contents of successive frames. Any or all of the frames of an interactive animated content file may be modified by the server and then sent to a requesting client device.

Additional information pertaining to types of information content transformation or customization is included in U.S. Pat. No. 7,072,984, entitled “System and method for accessing customized information over the internet using a browser for a plurality of electronic devices,” U.S. Patent Application Publication No. 2004/0049737, entitled “System and Method for Displaying Information Content with Selective Horizontal Scrolling,” and U.S. Pat. No. 7,500,188, entitled “System and Method for Adapting Information Content for an Electronic Device,” the entire contents of each of which are incorporated herein by reference as if fully set forth in this description.

Subsequently, the server may send the transcoded content to the client device, as shown at block 408.

If the information content includes video data, then the server will execute scripting language that may be associated with the information content, as shown at block 410. For example, a scripting language, such as Javascript, may be associated with or included within the information content. The server may include a scripting language engine associated with or included within a server browser that can execute the scripting language, which when executed, performs modifications to a DOM of the information content. For example, after retrieving the information content, the server may load the information content on a server browser, and when doing so, the server browser will execute inline script elements. The execution of the scripting language will result in modifications being made to the DOM. For example, in the case of video data, execution of the scripting language on the video data may append a new child node to the video data node that is either an embed or object tag that contains video source data. Alternatively, execution of the scripting language on the video data may append a child node to the video data node that contains text for a “Video not supported on this browser” message. As another example, in the case of non-video data, execution of the scripting language may add or replace child nodes to the non-video data node in the original DOM. As still another example, for a given node in the original DOM, execution of the scripting language may remove an anchor tag that points to a webpage and replace the anchor tag with another anchor tag pointing to a different web page.

At each position in the DOM where a modification is made due to execution of the scripting language, a switch node is inserted, as shown at block 412. For example, when executing the scripting language, if a modification is to occur on the DOM, a switch node is inserted when modifying a specific node. The switch node replaces an original node and includes two branches. A first branch of the switch node leads to the original node, and a second branch of the switch node leads to modifications made to the DOM due to execution of the scripting language. In this manner, the switch node operates to maintain the original format of the DOM, and also to include the modified format of the DOM.

As shown at block 414, if the switch node includes a first data content (e.g., video content), the switch node is marked. The switch node is a node of the DOM, and thus, may be marked by including an HTML attribute on the switch node. To identify if the switch node includes video content, the DOM as modified by the scripting language may be searched for embed or object tags, or other identifiers of video data. An embed or object tag, or other tag as preset or specified, may indicate that the node of the DOM includes or references video data, for example.

In this example, the first data content is video content. However, the first data content may be any type of selected data content that requires specific processing by the normalizer. For example, the first data content may be JPEG content, which may be processed in a specific manner. Alternatively, the first data content may be audio content, or text content. Any type of content may be selected and identified by marking a switch node, such that during normalization, the marked switch node can be processed in a manner different from an unmarked switch node, for example.

Following, the modified DOM is passed to a normalizer and processed accordingly, as shown at block 416. For example, the DOM is processed by following branches of the switch nodes such that for marked switch nodes, the modified branch is traversed and for unmarked switch nodes the original branches are traversed. Thus, in one example, once document parsing has completed and the scripting language has been executed, logic may be executed to determine which branch of inserted switch nodes to use during normalization of the DOM: original only, modified only, or detection of an “override” attribute on the switch node. The server will then normalize the information content following the indicated branches of the DOM, and send the normalized information content to the client device. To normalize the information content, the information content may be transcoded as needed.

The normalizer will follow original data branches for unmarked switch nodes, such that, unmarked switch nodes are basically removed from the modified DOM, for example. In this manner, any switch node that was inserted to replace an original node due to changes of the DOM as a result of execution of the scripting language that does not include or reference a selected data type (e.g., video data) will be essentially ignored by following the original data content of the DOM. In one example, for nodes that do not include video data, the original content of the DOM is maintained. For example, the modified version of the DOM is analyzed and processed such that when an unmarked switch node is encountered, changes by the scripting language are ignored because the switch node including an associated modified branch are not traversed so that the branch with original DOM content remains and is traversed. The DOM navigation operations determine how to traverse the switch nodes based on attributes of the switch nodes, for example.

In this manner, if the switch nodes were marked due to containing video content, video content of the marked switch nodes is processed. The video content may be processed by identifying a still image from the video content and replacing the video content with the still image (which may represent a preview of the video content) and a link. The image and the link may be a placeholder for the video data, for example. For example, the server will retrieve or generate a snapshot of the video, such as a still image of a first frame of the video, to include in or reference within the information content to be presented to the client device. The server may also include a link selectable by the user of the client device to instruct the server to transcode the video file into a format that may be displayed on the client device. Thus, when provided to a client device, the link may be selected to request that the video content be transcoded for viewing on the client device.

Alternatively, the video content may be processed by transcoding the video content, and inserting a reference to the transcoded video content in the DOM, for example. Modifying digital video from a digital video stream having one characteristic to a video stream having a different characteristic is referred to generally as video transcoding, and the video file may be transcoded into a format for display on a client device using many different techniques. Examples of different characteristics include video encoding format (e.g. MPEG1 and MPEG2) and data rates, such as affected by different quantization values. When all the video information of one video stream is maintained during a transcoding, a video stream lossless transcoding is said to occur. For Lossless transcoding to occur, the bandwidth available to the second video stream needs to be sufficient to support the data present in the original video stream. In one example, lossless video transcoding between video encoding formats can be accomplished by decoding a first video stream having a first video encoding format to generate rendered data (image data), followed by encoding the rendered data to generate a second video data stream having a second video encoding format.

Other examples of transcoding include a typical video file in an MPEG2 format being transformed for viewing on a client device by lowering the resolution of the video or lowering a frames per second display rate, by removing some of the frames. Specifically, the MPEG2 stream that was broadcast for television receivers can be transformed to a low-resolution stream, such as an MPEG4 stream, for example. A transcoder can receive the MPEG2 stream and decompress compressed video data contained in the MPEG2 stream. The transcoder can then convert the received video data to, for example, a resolution of 360 pixels times 240 lines and to 10 frames/second for the mobile client device, for example.

In addition, transcoding may include changing the video size from one size to another (also referred to as scaling). This may involve taking a larger video and scaling the video down to a smaller size to reduce an amount of bandwidth required to send the video to the client, and to ensure that the client device is able to display the resulting video. Since many clients fail when receiving a video size that is too large, sending a video that is too large may result in entirely wasted bandwidth. Thus, determining a correct scaling factor for each mobile device can be useful.

Other transcoding techniques involve compression of the video files. Video files use compression to reduce the size. A full size video in its raw format would be too large for many devices. Hence “codecs” or types of compression algorithms are used to reduce the size of the video into a file format that can be decoded later. However, when such a process is performed, quality can be degraded and some codecs are even “lossy” to reduce an amount of data needed to display the video. This is usually performed by digitizing a first frame of a video into data known as an I-frame and then comparing the first frame to a next frame. Only the differences between the two frames may be recorded into a P-frame. In this manner, not all the frames have to be digitized, but only the differences between the frames, which results in less data being used to store the video. Other I-frames may also be sent at some interval to allow recovery from any data corruption that may have occurred during transmission.

Since many different codecs or types of compression exist for video (both for the visual and audible components of the video file), it can be helpful to know which clients support certain codecs. Detecting which clients support which formats allows for selecting a video quality to be sent to a specific client. For example, AMR-NB (Narrow Band) is a type of audio codec that is optimized to be small in size and good for human voices, however, the codec may not be good quality for music. MP4 Audio, however, is a format that is larger and supported on fewer clients but has been found to be acceptable for music and multimedia.

When presented to the client device, the transcoded video may be streamed to the client. Streaming allows the video to start playing without requiring the entire video file to be downloaded. Streaming also allows the client to free up memory used by already viewed portions of the video. Streaming requires splitting up the video file into small packets that could be sent to a client one by one. The process of splitting the video file into packets is called “hinting”, which includes preparing the packets to be split and informing a streaming server how to send the split packets to the client. Many streaming servers require a video file to be hinted prior to streaming the video to clients. A video file that is not hinted may fail to be streamed and a client would therefore receive an error.

For more information regarding transcoding video data, the reader is referred to U.S. Patent Application Publication No. 2008/0195698, entitled “Method and System for Transforming and Delivering Video File Content for Mobile Devices” and U.S. Patent Application Publication No. 2008/0195692, entitled “Method and System for Converting Interactive Animated Information Content for Display on Mobile Devices”, the entire contents of each of which are incorporated herein by reference as if fully set forth in this description.

Returning to FIG. 4, next, the processed DOM is output, as shown at block 418. For example, the processed DOM including processed video content may be provided to a client device. In addition, the scripting language associated with the information content may also be provided to the client device. In this manner, the client device may display the information content, and when doing so, execute the scripting language. The scripting language may perform usual duties, such as inserting dropdown menus for example, on the original content of the DOM. The processed video content may further include renamed identifiers such that when the scripting language is executed, the scripting language will not modify the processed video content. In this regard, the processed video content may be hidden from the scripting language, such that the client device may execute the scripting language to perform all operations as intended with the exception of modifying the processed video content.

If the scripting language were to execute and modify processed video content on a client device that does not support this type of video content, the scripting language would replace the processed video content with an image and text that reads “unable to support video”, for example. However, by hiding processed video content from the scripting language, a client device that does not support video content may execute the scripting language and display the processed video content, which may only include a still image and a link, for example.

The method 400 operates to preserve original content of the DOM, and to adapt video content for the client device. In addition, the scripting language associated with the information content can still be sent to client device and executed by the client device, rather than the server executing the scripting language and fully modifying the DOM, which would then be sent to the client device without the scripting language. By sending the scripting language to the client device, the client device may perform more functionality of the website.

Furthermore, by sending the processed video data to the client device in a format of a preview image and link, a user of the client device may select the link to request the video for display. The server may receive the request, adapt the video for viewing on the client device, and send the adapted or transcoded video to the client device. Videos may be converted based on capabilities of the client device or capabilities of a client browser.

Alternatively, after receiving a user selection of the link, the server may transcode the video data and notify the user when the video conversion is complete. The server may notify the user in any number of ways, such as for example, using a Short Message Service (SMS) or Push messaging that includes link to allow the user to watch the video. The notification message may include an identifier, which links to the associated transcoded video file. The server may place a video file identifier into the notification prior to the server sending the notification message to client device. The client device, in turn, may send the identifier to the server to retrieve the associated transcoded video file.

Thus, according to example embodiments, the server may add switch nodes to the DOM, and mark the switch nodes that relate to video content. Once the nodes are added to the DOM and marked, the server (e.g., adaptive content accelerator (ACA)) can be operated to add an image and a real time streaming protocol (RTSP) link to the DOM. Pre-processing of the scripting language occurs to identify nodes related to video, and to maintain other original nodes.

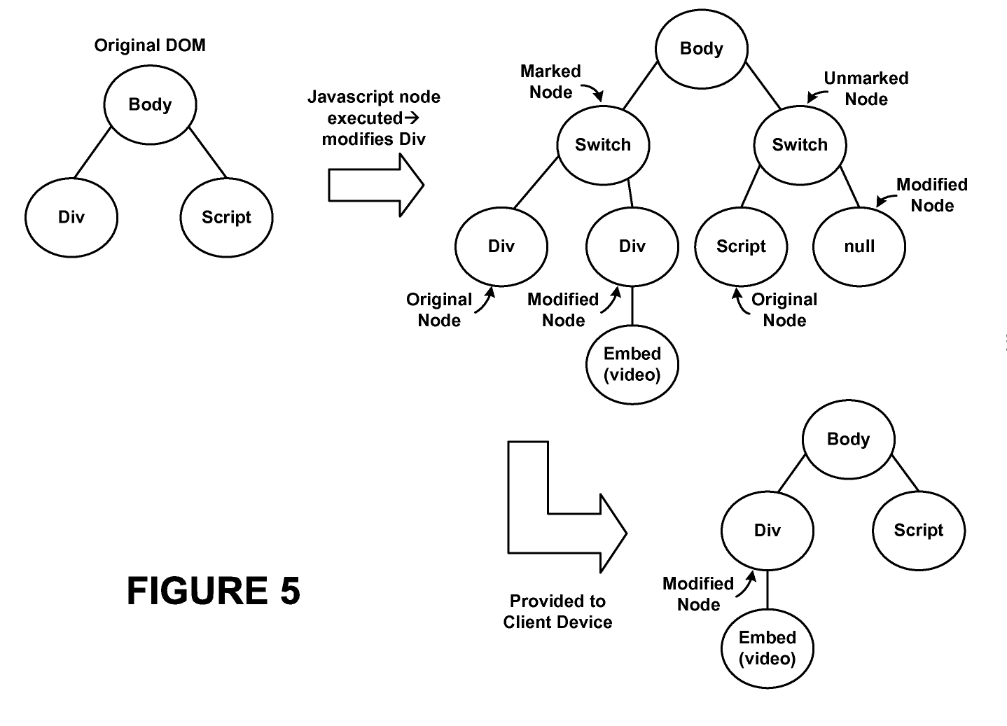

FIG. 5 is another example conceptual DOM represented as a tree structure. In this example, the original DOM includes a body element that has branches to a division tag (e.g., “div”) and a script tag. Upon executing of a scripting language associated with the DOM, the div and script nodes may be modified, and thus, switch nodes are inserted into the DOM at positions of the original div and script nodes. The switch nodes store two versions of the “div” and “script” nodes. For example, a first version includes original content of the DOM and a second version includes modified data. For the switch node representing the script node, two branches are included that represent the original node (e.g., the script node) and a modified node. The modified branch of the “script” node is null since this node will have been executed.

In this example, the div tag includes video data. For the switch node representing the div node, two branches are included that represent the original div node, and a modified node. The modified node includes the div tag and an embed tag. The embed/object tag may include reference to a still image of video content and a link, as discussed above.

Logic of a server to detect the embed/object tags from this example can be augmented to search the original DOM for these tags. If one is found, then a next step may be to find all ancestor switch nodes in such a branch and set an attribute referred to as “override” on those nodes. This will have an effect of causing any further DOM operations on those nodes to use the modified branch. A normalizer of the server may then run the embed/object tags through a video transcoder and update a normalized DOM with the resulting content.

After processing video data of the div tag belonging to a marked switch node, unmarked switch nodes are removed, for example, and the resulting modified DOM can be provided to a client device. In addition, the marked switch node itself can be removed prior to sending the modified DOM to the client device. The example in FIG. 5 allows the original DOM to carry before and after knowledge for all nodes affected by a scripting language. Furthermore, in the event that a scripting language executing on the client device may attempt to overwrite the video content generated by the server, the “id” attribute on the “div” tag that encapsulates the video data could be changed, for example, so that the scripting language will not overwrite the content.

FIGS. 6-12 illustrate example conceptual DOMs represented as a tree structure, and instances in which the DOMs are modified due to execution of a scripting language.

FIG. 6 illustrates an example conceptual DOM represented as a tree structure, and an instance in which a scripting language modifies a script node. As a document parser executes the scripting language and encounters the script node, a QuickDom switch state is set to insert indicating all DOM changes should insert a switch node. As seen in FIG. 5, the original script node will be replaced by a switch node that has two branches. A state attribute of the switch node is set to “original”. The original script tag node and all children of the script tag node become a first child (original branch) of the switch node, and “null” will be left as a modified branch of the switch node, which is set as the last or second child of the switch node.

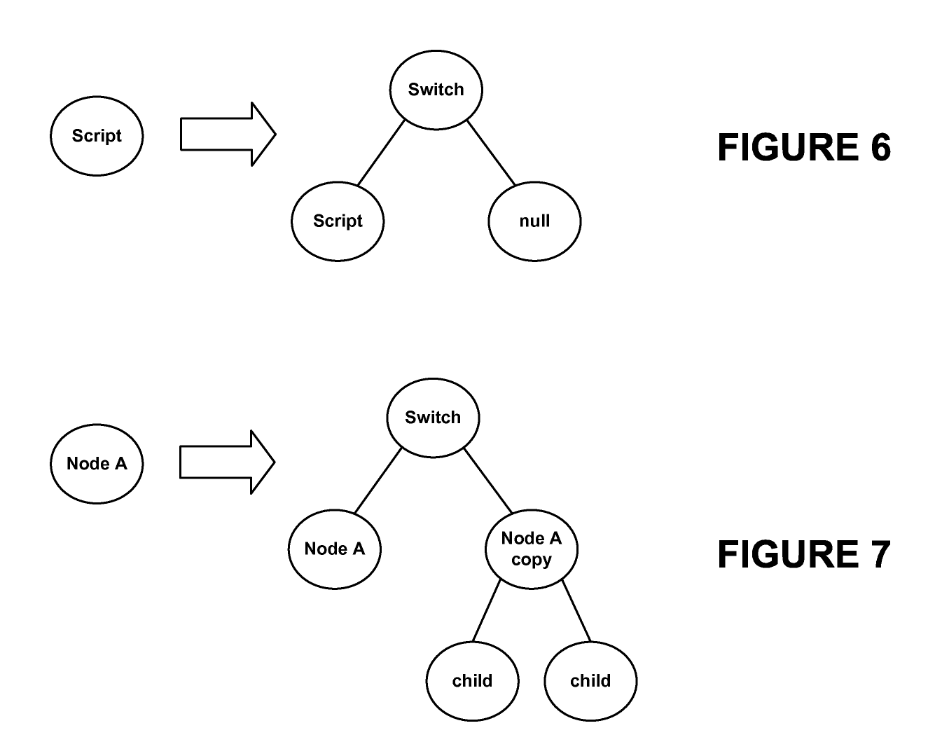

FIG. 7 illustrates an example conceptual DOM represented as a tree structure, and an instance in which a scripting language modifies a general node. If a parent of node A is already a switch node, children of node A can be simply appended to a copy of node A. However, if a parent of node A is not a switch node, then a switch node is created and inserted in place of node A. Original node A becomes a first child of the switch node and a copy of node A becomes the second child (modified branch). All children can then be appended to the copy of node A.

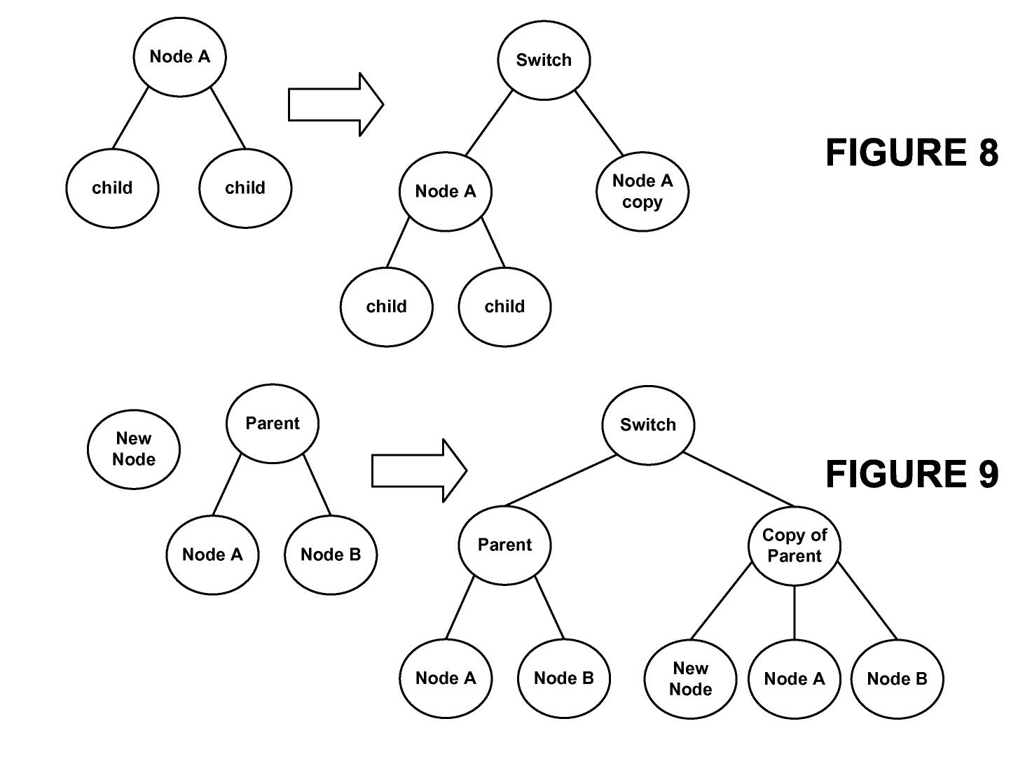

FIG. 8 illustrates an example conceptual DOM represented as a tree structure, and an instance in which a scripting language modifies a general node by removing children. If a parent of node A is already a switch node, children of node A can simply be removed. However, if a parent of node A is not a switch node, then a switch node is created and inserted in place of node A. Original node A and children become a first child of the switch node and a copy of node A becomes the second child (e.g., modified branch). All children are removed from the copy of node A (e.g., modified branch).

FIG. 9 illustrates an example conceptual DOM represented as a tree structure, and an instance in which a scripting language modifies the DOM by inserting a new node before the node being modified. If a parent of node A is already a switch node, a new node can be inserted before node A. However, if a parent of node A is not a switch node, then a switch node is created and inserted in place of node A. The original parent node becomes a first child of the switch node and a copy of the parent node and its children become a second child (e.g., modified branch). Using the copy of the parent node, a new node is inserted before node A.

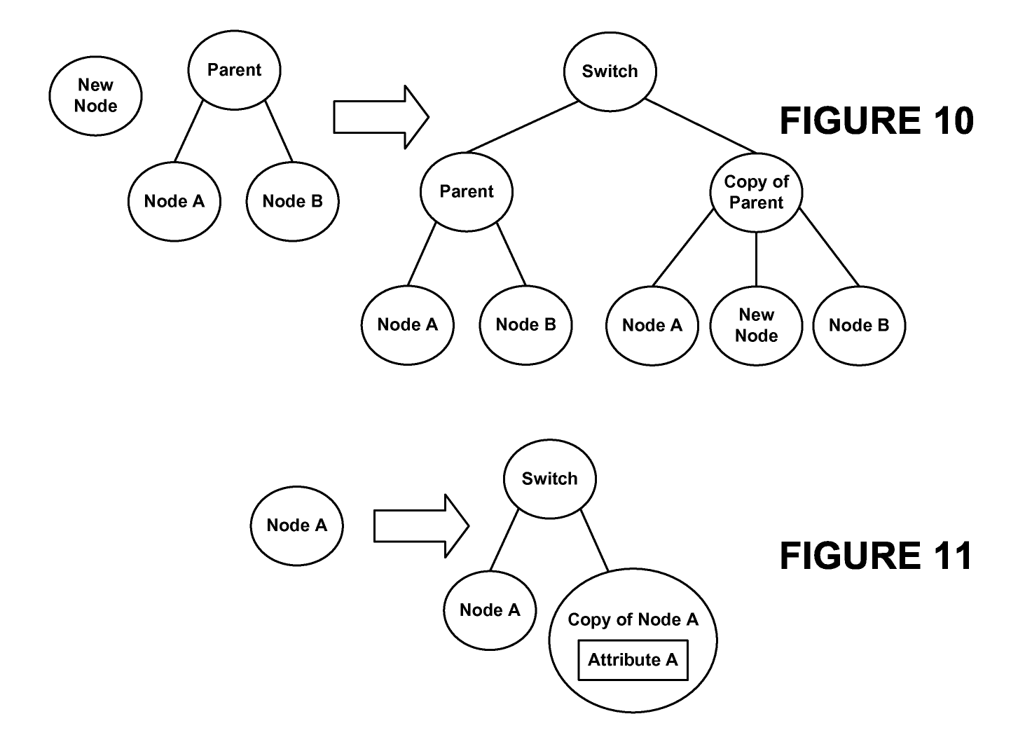

FIG. 10 illustrates an example conceptual DOM represented as a tree structure, and an instance in which a scripting language modifies the DOM by inserting a new node after the node being modified. If a parent of node A is already a switch node, a new node can be inserted after node A. However, if a parent of node A is not a switch node, then a switch node is created and inserted in place of node A. The original parent node becomes a first child of the switch node and a copy of the parent node and its children become a second child (e.g., modified branch). Using the copy of the parent node, a new node is inserted after node A.

FIG. 11 illustrates an example conceptual DOM represented as a tree structure, and an instance in which a scripting language modifies a node by altering an attribute value. If a parent of node A is already a switch node, a new attribute of node A can be set. However, if a parent of node A is not a switch node, then a switch node is created and inserted in place of node A. The original node A becomes a first child of the switch node and a copy of node A becomes a second child (e.g., modified branch). Using the copy of node A, a new Attribute A can be set.

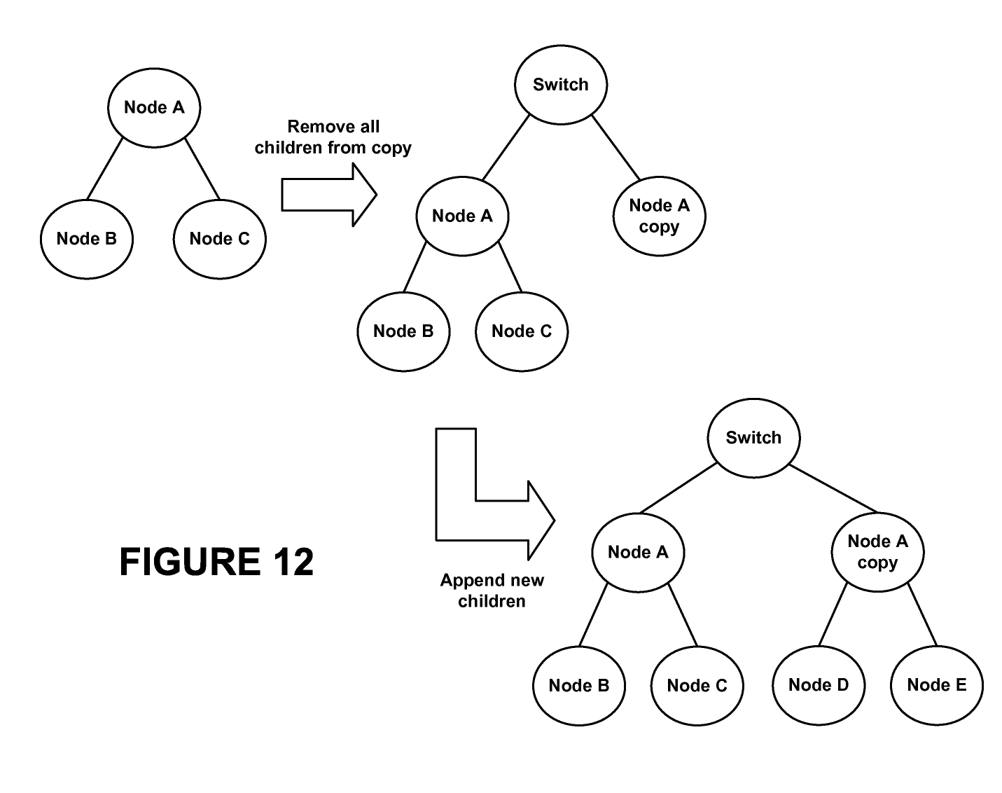

FIG. 12 illustrates an example conceptual DOM represented as a tree structure, and an instance in which a scripting language modifies replaces children of a given node with contents specified as an HTML string (e.g., performs Javascript function “setInnerHtml”). If a parent of node A is already a switch node, all children of node A can be removed and new children can be appended. However, if a parent of node A is not a switch node, then a switch node is created and inserted in place of node A. The original node A and children become a first child of the switch node and a copy of node A becomes a second child (e.g., modified branch). Following, children nodes can be removed from the copy of node A, and new children generated by the input HTML text can be appended to the copy of Node A (e.g., shown as Nodes D and E).

In a further example, as described above, when a parent or ancestor of a node is a switch node, the node will not be replaced by another switch node. In addition, attributes of the switch nodes will dictate which branch to follow.

In examples in which an embed or object tag is encountered, a parent switch node of the embed or object tag will have an attribute set to “override” to indicate that the modified branch should be used in all future traversal operations. Further, all parents of the switch node may have attributes set to “override” as well.

After switch nodes have been inserted, the modified DOM is passed to a normalizer for processing so as to process the video data. The normalizer may attempt to normalize a switch node, however, if the “override” attribute is set on the switch node, the modified branch is followed and a first child node of the modified branch is copied and returned. Normalization continues down the modified branch with the original branch being ignored. If an embed or object tag is detected, the tag is passed into example logic that runs the node through the video processing solution and resulting video content is appended to the normalized DOM. All other switch nodes encountered will normalize children from the original branch per the switch state. Ultimately, the normalized DOM will not contain any switch nodes, but only those nodes belonging to branches specified by the switch state, for example.

Example methods described may use a QuickDom normalizer function to perform functions on the original DOM. The QuickDom normalizer may have classes such as SwitchState that describes what branch to follow for a given switch node (e.g., defaults to Original). The values of SwitchState include original (follow original branch), insertion (currently inserting content), modified (follow modified branch), and override (supercedes overall DOM Switch state setting).

The QuickDom normalizer may further includes methods that may be executed include those shown below in Table 2. Other classes and methods as described may also be included in the QuickDom normalizer.

TABLE 2

| | |
|---|---|
| setDOMSwitch(int mode, String override)/getDOMSwitch( ) | Sets attribute of switch |
| | node |
| getParentSwitchNode | Locates parent switch |
| | node |
| getAncestorSwitchNode/getAncestorSwitchNodes | Locates ancestor switch |
| | node |
| getDescendantSwitchNode/getDescendantSwitchNodes | Locates descendant |
| | switch nodes |
| getChildSwitchNode | Locates child switch |
| | node |
| appendChild/appendChildren | Append child nodes |
| buildTagNode | Creates video tag node |
| countAllDescendants | Counts all descendant |
| | nodes |
| createTagNode | Creates tag node |
| createAttributeNode | Create attributes for a |
| | node |
| copyNode | Copy a node |
| getAllDescendants/getAllTruncatedDescendants/ | Locates all descendants |
| getTruncatedDescendants/getTruncatedDescendantsByAttributeValue | by value |
| getAllAncestors/getAncestor/getAllAncestorsInSameWindow | Locates all ancestors |
| getFirstDescendant | Locates a first |
| | descendant |
| getNearestPreviousElement | Locates a nearest node |
| getChildren/getChildrenNoTextNodes | Locates children |
| getFirstChild/getLastChild | Locates first child |
| getNextSibling/getPreviousSibling | Locates a next sibling |
| getParent | Locates a parent node |
| insertAfter/insertBefore | Inserts a node |
| | before/after |
| remove/removeAttribute/removeChildren/removeKeepChildren | Removes children |

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of providing information content for display comprising:
receiving information content that is represented by a document object model (DOM) and that includes a scripting language associated with the information content;
executing the scripting language on the DOM resulting in modifications being performed on the DOM;
inserting a switch node into the DOM at positions where the scripting language modified the DOM, the switch node having a first branch that indicates original content of the DOM and a second branch that indicates modifications performed by the scripting language;
if the switch node has a branch that indicates a first data content, marking the switch node;
processing the DOM by following branches of the switch nodes such that for marked switch nodes modified branches are traversed and for unmarked switch nodes original branches are traversed; and
outputting a processed DOM.

2. The method of claim 1, further comprising providing an attribute on each switch node indicating which branch to use.

3. The method of claim 1, wherein executing the scripting language on the DOM transforms the DOM in a modified version of the DOM, and the method further comprises:
comparing the DOM with the modified version of the DOM; and
inserting the switch node into the DOM at positions where the scripting language modified the DOM.

4. The method of claim 1, wherein marking the switch node comprises providing an attribute on the switch node if the switch node includes an <embed> or <object> tag.

5. The method of claim 1, wherein the first data content is video content.

6. The method of claim 5, wherein the video content includes content selected from the group consisting of flash content and MPEG content.

7. The method of claim 5, wherein processing the DOM for marked switch nodes comprises processing the video content.

8. The method of claim 7, further comprising within the processed DOM, providing identifiers on nodes including processed video content, the identifiers indicating to the scripting language not to perform modifications to the nodes when the scripting language is executed on a client device.

9. The method of claim 7, wherein processing the video content comprises replacing the video content with a preview image and a link.

10. The method of claim 9, further comprising:
receiving a user selection of the link;
transcoding the video content; and
providing transcoded video content.

11. The method of claim 1, wherein outputting the processed DOM includes providing the scripting language associated with the information content.

12. The method of claim 1, further comprising:
receiving a request for the information content from a client device; and
retrieving the information content from an information source.

13. The method of claim 1, further comprising:
making a determination whether the information content includes video content; and
based on the determination, executing the scripting language on the DOM.

14. The method of claim 1, further comprising:
identifying all ancestor switch nodes in a branch that includes the first data content; and
setting an attribute on the ancestor switch nodes to indicate to use modified branches.

15. The method of claim 1, wherein a node of the DOM is a script node, and wherein inserting the switch node into the DOM comprises:
replacing the script node with the switch node;
placing the script node in the first branch of the switch node as a first child of the switch node; and
placing a null in the second branch of the switch node as a second child of the switch node.

16. The method of claim 1, wherein a node of the DOM is modified by the scripting language, and wherein inserting the switch node into the DOM comprises:
replacing the node with the switch node;
placing the node in the first branch of the switch node as a first child of the switch node; and
placing a copy of the node in the second branch of the switch node as a second child of the switch node.

17. The method of claim 16, further comprising appending children of the node to the copy of the node.

18. A computer readable medium having stored therein instructions executable by a computing device to cause the computing device to perform functions of:
receiving information content that is represented by a document object model (DOM) and that includes a scripting language associated with the information content;
executing the scripting language on the DOM resulting in modifications being performed on the DOM;
inserting a switch node into the DOM at positions where the scripting language modified the DOM, the switch node having a first branch that indicates original content of the DOM and a second branch that indicates modifications performed by the scripting language;
if the switch node has a branch that indicates a first data content, marking the switch node;
processing the DOM by following branches of the switch nodes such that for marked switch nodes modified branches are traversed and for unmarked switch nodes original branches are traversed; and
outputting a processed DOM.

19. The computer readable medium of claim 18, wherein the instructions are further executable to perform a function of providing an attribute on each switch node indicating which branch to use.

20. The computer readable medium of claim 18, wherein the first data content is video content, wherein processing the DOM for marked switch nodes comprises processing the video content, and wherein processing the video content comprises replacing the video content with a preview image and a link.

21. A server comprising:
a processor;
memory including machine language instructions executable by the processor to perform functions comprising:
receiving information content that is represented by a document object model (DOM) and that includes a scripting language associated with the information content;
executing the scripting language on the DOM resulting in modifications being performed on the DOM;
inserting a switch node into the DOM at positions where the scripting language modified the DOM, the switch node having a first branch that indicates original content of the DOM and a second branch that indicates modifications performed by the scripting language; and
if the switch node has a branch that indicates a first data content, marking the switch node;
a normalizer for processing the DOM by following branches of the switch nodes such that for marked switch nodes modified branches are traversed and for unmarked switch nodes original branches are traversed, wherein the normalizer outputs a processed DOM.

22. The server of claim 21, wherein a node of the DOM is modified by the scripting language, and wherein the function of inserting the switch node into the DOM comprises:
replacing the node with the switch node;
placing the node in the first branch of the switch node as a first child of the switch node; and
placing a copy of the node in the second branch of the switch node as a second child of the switch node.

23. The server of claim 21, wherein the first data content is video content, and wherein the normalizer processes the video content by replacing the video content with a preview image and a link, wherein in response to a user selection of the link, the normalizer transcodes the video content.
